(19) United States
(12) Patent Application Publication
(10) Pub. No.: US 2012/0174787 A1
(43) Pub. Date: Jul. 12, 2012

(54) FILTER HAVING FLOW CONTROL FEATURES

(75) Inventors: Vishal Bansal, Lees Summit, MO (US); Peter Martin Maly, Santa Ana, CA (US); Robert Warren Taylor, Ponte Vedra Beach, FL (US)

(73) Assignee: General Electric Company, Schenectady, NY (US)

(21) Appl. No.: 13/005,377

(22) Filed: Jan. 12, 2011

(51) Int. Cl. B01D 50/00; B01D 71/36; B01D 53/34; B01D 39/14; B01D 39/08; B01D 46/02; B01D 46/00

(52) U.S. Cl. 95/284; 55/522; 55/527; 55/486; 55/487; 55/488; 96/12; 96/154; 422/177; 422/211

(57) ABSTRACT

A system including, a filter having an exterior surface, wherein the exterior surface contains a three-dimensional surface morphology.

### BACKGROUND OF THE INVENTION

The subject matter disclosed herein relates to fluid filters. More specifically, the disclosed subject matter relates to filters used in various industrial and commercial applications.

Filters are used in a variety of equipment and applications, such as intake and exhaust filtration. For instance, a bag house may include multiple filter bags to filter particulates associated with an industrial system or plant. In particular, the bag house may be equipped with a sufficient number and size of filter bags to filter particulates from an industrial process, such as in a cement factory. Emissions standards are becoming increasingly stringent, requiring more efficient filtration systems. At certain times during operation, the filter bags may be agitated to remove particulate buildup. Unfortunately, the agitation of the filter bag may result in a spike of undesirable emissions (e.g., mercury). However, without periodic agitation, the particulate buildup increases system pressure drop, because the particulate buildup substantially blocks flow through the filter bag and increases pressure loss.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a filter having a wall and a surface on the wall. A three-dimensional surface morphology is disposed along the surface, and is configured to reduce a pressure drop across the filter.

In a second embodiment, a system includes a filter having a wall and a surface on the wall. A three-dimensional surface morphology having a non-uniform pattern is disposed along the surface. The non-uniform pattern progressively changes in a direction along the filter.

In a third embodiment, a method includes decreasing a pressure drop through a filter via a three-dimensional surface morphology disposed along a surface of the filter. The method further includes increasing a retention of a particulate buildup along the surface of the filter via the three-dimensional surface morphology.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of an embodiment of a bag house connected to a commercial/industrial system;

FIG. 2 is a partial side view of an embodiment of a blowpipe configured to pulse air into a filter bag;

FIG. 3 is a partial surface view taken within arcuate line 3-3 of FIGS. 1 and 2, depicting an embodiment of a three-dimensional surface morphology arranged in a uniform pattern along an exterior surface of a filter bag;

FIG. 4 is a partial surface view taken within arcuate line 3-3 of FIGS. 1 and 2, depicting an embodiment of a three-dimensional surface morphology arranged in a node and link pattern along an exterior surface of a filter bag;

FIG. 5 is a partial surface view taken within arcuate line 3-3 of FIGS. 1 and 2, depicting an embodiment of a three-dimensional surface morphology arranged in a variable density pattern along an exterior surface of a filter bag;

FIG. 6 is a partial surface view taken within arcuate line 3-3 of FIGS. 1 and 2, depicting an embodiment of a three-dimensional surface morphology arranged in a variable sized pattern along an exterior surface of a filter bag;

FIGS. 7, 8, and 9 are partial cross-sectional side views of a wall of a filter bag, illustrating a base layer and a cover layer with different embodiments of the three-dimensional surface morphology;

FIG. 10 is cross-sectional side view of an embodiment of a filter bag having a three-dimensional surface morphology on the surface of the filter bag, illustrating collection of a particulate buildup prior to a pulse jet cleaning;

FIG. 11 is a cross-sectional side view of an embodiment of a filter bag having a three-dimensional surface morphology on the surface of the filter bag, illustrating a pulse jet cleaning causing partial removal and partial retention of particulate buildup;

FIG. 12 is a cross-sectional side view of an embodiment of a filter bag having a three-dimensional surface morphology with protrusions from the surface of the filter bag;

FIG. 13 is a cross-sectional side view of an embodiment of a filter bag having a three-dimensional surface morphology with protrusions and recesses along the surface of the filter bag;

FIG. 14 is a partial cross-sectional side view taken within arcuate line 14-14 of FIGS. 10 and 13, depicting a surface of a filter bag having a three-dimensional surface morphology with protrusions and recesses to cause a more porous collection of particulate buildup;

FIG. 15 is a partial cross-sectional side view of a wall of an embodiment of a filter having a three-dimensional surface morphology, illustrating dimensional relationships between particulate buildup, fibers in the wall, and the three-dimensional surface morphology;

FIG. 16 is a partial cross-sectional side view of the filter taken within arcuate line 16-16 of FIG. 15, further illustrating the dimensional relationships between fibers in the filter surface and the three-dimensional surface morphology disposed on the filter surface;

FIG. 17 is a graph of pressure drop versus time, illustrating the difference between a filter having a three-dimensional surface morphology and a filter without the three-dimensional surface morphology;

FIG. 18 is a cross-sectional side view of an embodiment of an accordion-style filter bag configured with a three-dimensional surface morphology; and

FIG. 19 is a cross-sectional top view of an embodiment of ribbed filter bag configured with a three-dimensional surface morphology.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed to a filter (e.g., a filter bag) that includes a three-dimensional surface morphology on a surface (e.g., an exterior or interior surface) of the filter. Although the following discussion primarily describes the three-dimensional surface morphology in context of filter bags, the three-dimensional surface morphology may be employed on any type or construction of filters. The filter (e.g., filter bags) employing the three-dimensional surface morphology may be found in a variety of industries, including food, pharmaceutical, chemical, paint, cement, plastic, alumina, combustion, power generation, and steel. Any application that needs filters (e.g., coal burning, utility, or furnace) may take advantage of the three-dimensional surface morphology filters, according to an aspect of the present invention. In general, a particulate buildup on a filter causes a pressure drop, which gradually increases during operation of the filter. Upon reaching a cleaning time interval or a pressure drop set point, due to particulate buildup on the surface of a filter (e.g., filter bag), a cleaning system may be used to purge the particulate buildup on the filter. Unfortunately, filter cleanings may cause a spike in undesirable emissions (e.g., mercury) from the system. For example, an activated carbon sorbent may be injected into the flow upstream from the filter to sorb (e.g., adsorb and/or absorb) mercury vapor or other emissions, such that the filter is able to collect the mercury as the activated carbon sorbent is captured by the filter. Unfortunately, the filter itself may not be particularly effective at capturing the activated carbon sorbent due to its small particle size, whereas the particulate buildup may be more effective at capturing the activated carbon sorbent. As a result, each cleaning of the filter may cause a partial release of the mercury, thereby causing a spike in mercury emissions. In the disclosed embodiments, the three-dimensional surface morphology may be configured to retain at least some particulate buildup on the filter to enable efficient capture of certain emissions (e.g., mercury sorbed on an activated carbon sorbent), while also reducing the pressure drop caused by the particulate buildup to reduce the frequency of filter cleanings.

As discussed in detail below, the three-dimensional surface morphology, according to one aspect of the invention, may permit a more porous collection of particulate buildup inside the filter media or on the surface of the filter (e.g., filter bags), thus reducing the pressure drop caused by the gradually increasing particulate buildup. The reduction in pressure drop may have the benefit of reducing the frequency of necessary cleanings, because the filter is able to effectively filter particulate despite a greater amount of particulate buildup. Again, the three-dimensional surface morphology is configured to retain a portion of particulate before and after filter cleanings, thereby improving the filtration of fine particulate matter (e.g., activated carbon sorbent that sorbs mercury vapor). For example, a certain amount of the particulate buildup may help to improve filtration of other particulate and/or vapor from a gas flow, while excessive particulate buildup may gradually reduce flow and degrade performance of the filter bag. Thus, the three-dimensional surface morphology may have a pattern, spacing, and geometry specifically correlated to the particulate size, desired retention of particulate, desired porosity of the particulate buildup, and other factors. As a result of these design features, the three-dimensional surface morphology enables a greater flow due to a more porous buildup of particulate, while retaining a portion of the particulate buildup to improve filtration. Thus, the three-dimensional surface morphology may reduce undesirable emissions (e.g., mercury) by reducing the frequency of cleaning the filter, and also by retaining a portion of the filtered particulate on the surface of the filter.

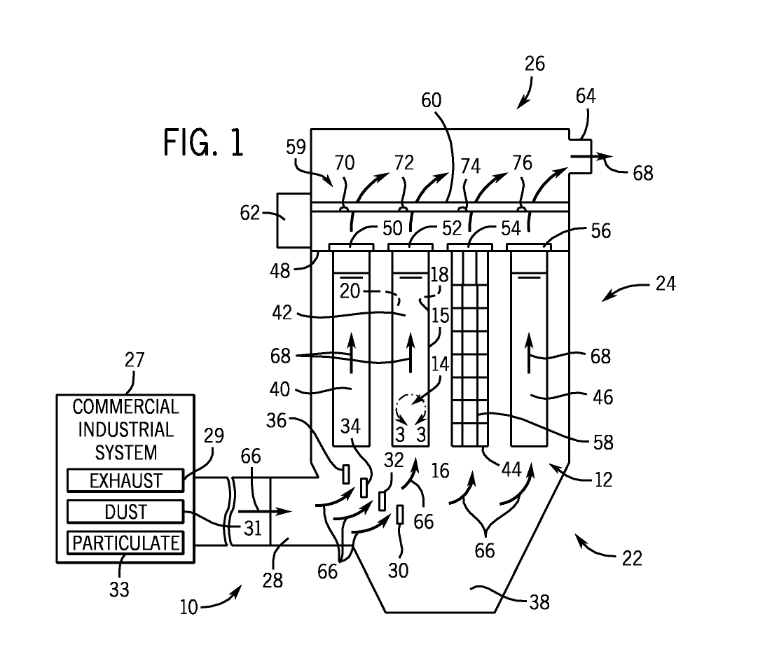

FIG. 1 is a cross-sectional view of an embodiment of a bag house 10 that houses a plurality of filter bags 12 with a three-dimensional surface morphology 14. In the illustrated embodiment, the three-dimensional surface morphology 14 is disposed on a wall 15, e.g., an exterior surface 16, of the filter bags 12. The wall 15 may be a fabric layer made of a fabric, such as woven or felted fabrics made of natural or synthetic fibers. Exemplary fibers include natural fiber cellulose, polyolefin, natural fiber protein, polyester, or a fluoro-carbon. Alternatively, the wall 15 may be polytetrafluroethylene (ePTFE) micro-porous membrane. However, embodiments of the filter bags 12 may include the three-dimensional surface morphology 14 on the exterior surface 16 and/or an interior surface 18 of the wall 15. As discussed in detail below, the three-dimensional surface morphology 14 may include a uniform or non-uniform pattern of recesses and/or protrusions. For example, the three-dimensional surface morphology 14 may include equal or different sized (e.g., length, width, and height) recesses and/or protrusions distributed along the exterior surface 16 and/or an interior surface 18. By further example, the three-dimensional surface morphology 14 may include an equal or varying density of recesses and/or protrusions (e.g., number per area) distributed along the exterior surface 16 and/or an interior surface 18. The three-dimensional surface morphology 14 is configured to increase the porosity of particulate buildup along the filter bags 12 (e.g., exterior surface 16), thereby substantially increasing flow through the particulate buildup to decrease the frequency of filter bag cleanings and reduce undesirable emissions (e.g., mercury).

Many filter cleaning systems may be utilized to clean filters including shaker, reverse gas, and plenum pulse mechanisms. The current embodiment uses a pulse jet cleaning system, but is not intended to preclude the use of other cleaning mechanisms. In the current embodiment, the bag house 10 may include three sections: an air inlet section 22, an air cleaning section 24, and an air outlet section 26. The air inlet section 22 includes a dirty gas inlet 28; baffles 30, 32, 34, and 36; and a hopper 38. The air cleaning section 24 includes the filter bags 12 (e.g., filter bags 40, 42, 44, and 46); upper support or tube sheet 48; cage covers 50, 52, 54, and 56; and cages 58 within the filter bags 40, 42, 44, and 46. The air outlet section 26 includes a pulse jet cleaning system 59 having a blowpipe 60 coupled to a compressed air header 62, such that a pulse jet may be used to agitate and clean each of the filter bags 40, 42, 44, and 46. The air outlet section 26 also includes a clean air outlet 64.

The bag house 10 allows dirty air 66 (e.g., an air flow or other gas flow carrying particulate matter, vapor, or other contaminants) to enter the air inlet section 22 through the dirty gas inlet 28. For example, a commercial or industrial system 27 may output an exhaust 29, dust 31, and/or particulate 33 as the dirty air 66 to the dirty gas inlet 28 of the bag house 10. The dirty air 66 after passing through the dirty gas inlet 28 contacts the baffles 30, 32, 34, and 36. The baffles 30, 32, 34, and 36 direct the dirty air 66 in a direction towards the clean air outlet 64. As the dirty air 66 moves in the direction of the clean air outlet 64, the dirty air 66 contacts the filter bags 12 (e.g., fabric filter bags 40, 42, 44, and 46). The filter bags 40, 42, 44, and 46 allow air to pass through the wall 15 from the exterior surface 16 to the interior surface 18, and then along an interior 20 of the filter bags 40, 42, 44, and 46 toward the tube sheet 48. However, the filter bags 40, 42, 44, and 46 retain particulate inside the filter media and/or block entry of particulate along the exterior surface 16, which includes the three-dimensional surface morphology 14. Accordingly, as the dirty air 66 passes through the filter bags 40, 42, 44, and 46, the blocked particulate matter builds up on the exterior surface 16 of the filter bags 40, 42, 44, and 46 and/or drops into the hopper 38 for removal from the bag house 10. The clean air 68 within the filter bags 40, 42, 44, and 46 then continues to progress through the filter bags 40, 42, 44, and 46 until reaching the outlet section 26, where the clean air 68 is able to exit through the clean air outlet 64.

Each of the filter bags 40, 42, 44, and 46 attaches to the air cleaning section 24 with a mount along the tube sheet 48. For example, the mount may include a band that fits within an aperture of the tube sheet 48. While in the present embodiment, the tube sheet 48 includes four apertures one for each filter bag 40, 42, 44, and 46, it is understood that the tube sheet 48 may include more apertures, e.g., 10 to 100 apertures, or any number of filter bags. The filter bags 40, 42, 44, and 46 maintain their shape under the force of the dirty air 66, because of cages 58 placed into the filter bags 40, 42, 44, and 46. The cages 58 may be made out of materials, such as steel or other metals, plastics, or composite materials, that are able to resist deformation under the air pressure of the bag house 10. The cages 58 maintain the shape of the filter bags 40, 42, 44, and 46 under pressure from the dirty air 66 allowing the filter bags 40, 42, 44, and 46 to increase air filtration. The cages 58 attach to the cage covers 50, 52, 54, and 56. The cage covers 50, 52, 54, and 56 stabilize the filter bags during operation and facilitate insertion and removal of the cage 58 into and from the filter bags, facilitating the filter bag replacement process.

During operation of the bag house 10, the exterior surface 16 of filter bags 40, 42, 44, and 46 gradually becomes covered with filtered particulate, thereby increasing a pressure drop across the filter bags 40, 42, 44, and 46. The three-dimensional surface morphology 14 may help to delay this increase in pressure drop by providing a more porous coverage of the exterior surface 16. In particular, the three-dimensional surface morphology 14 enables a greater airflow through the particulate buildup on the exterior surface 16, thereby allowing a greater amount of particulate buildup before reaching an upper set point or threshold of pressure drop across the filter bags 40, 42, 44, and 46. Upon reaching the threshold, a cleaning system (e.g., pulse jet cleaning system 59) may be used to remove the particulate buildup from the exterior surface 16 of the filter bags 40, 42, 44, and 46. In the illustrated embodiment, the pulse jet cleaning system 59 periodically outputs pulsed jets of air (or another gas) into the filter bags 40, 42, 44, and 46 to knock particulate buildup off the filter bags 40, 42, 44, and 46 and into the hopper 38. As mentioned above, the pulse jet cleaning system 59 includes the blowpipe 60 coupled to the compressed air header 62, which provides pulses of compressed air into the blowpipe 60. The blowpipe 60 then directs the pulsed compressed air through openings 70, 72, 74, and 76 into the filter bags 40, 42, 44, and 46 as pulsed jets of compressed air. The pulsed jets agitate the filter bags 40, 42, 44, and 46 sufficiently to knock particulate buildup off of the exterior surface 16 into the hopper 38, thus reducing the thickness and/or density of the particulate buildup. Cleaning the filter bags 40, 42, 44, and 46 may create a temporary spike in certain emissions (e.g., mercury) as the particulate is removed from the exterior surface 16. The three-dimensional surface morphology 14 on the exterior surface 16 of filter bags 40, 42, 44, and 46 may help to solve this problem by retaining some of the particulate buildup on the exterior surface 16 of filter bags 40, 42, 44, and 46. The retained particulate buildup may substantially reduce the spike in certain emissions (e.g., mercury) during the cleaning process, while also serving to improve filtration during operation of the bag house 10.

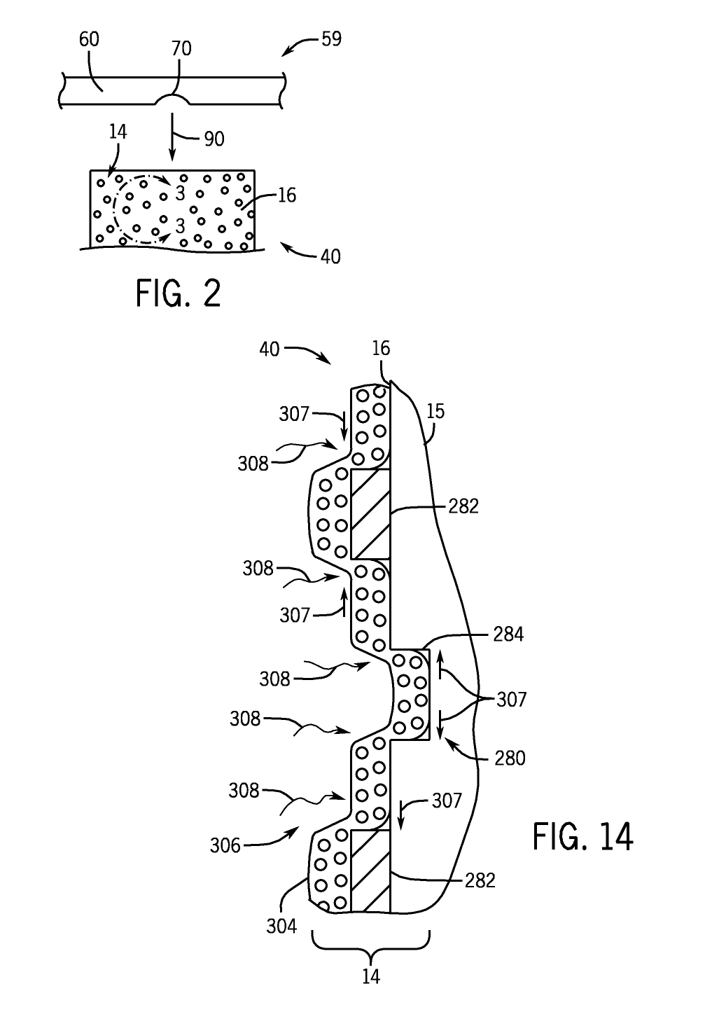

FIG. 2 is a partial side view of an embodiment of a blowpipe 60 pulsing air into a filter bag 40. As discussed above, the air outlet section 26 includes a blowpipe 60 that blows compressed air into the filter bags 40, 42, 44, and 46. The pulsed air from the compressed air header 62 travels through the blowpipe 60 and exits through the blowpipe aperture 70 in the form of air pulses 90. These air pulses 90 enter the filter bag 40 and cause it to shake, vibrate, and agitate sufficiently to knock particulate loose from the exterior surface 16 of the filter bag 40. The three-dimensional surface morphology 14 may help to decrease the frequency of pulse jet cleanings by causing a less-uniform and more porous particulate buildup to form on the surface 16 of filter bag 40. Furthermore, upon the pulsejet cleaning, the three-dimensional surface morphology 14 may help decrease transient emissions from the system by retaining a portion of the porous buildup contacting the three-dimensional surface morphology 14.

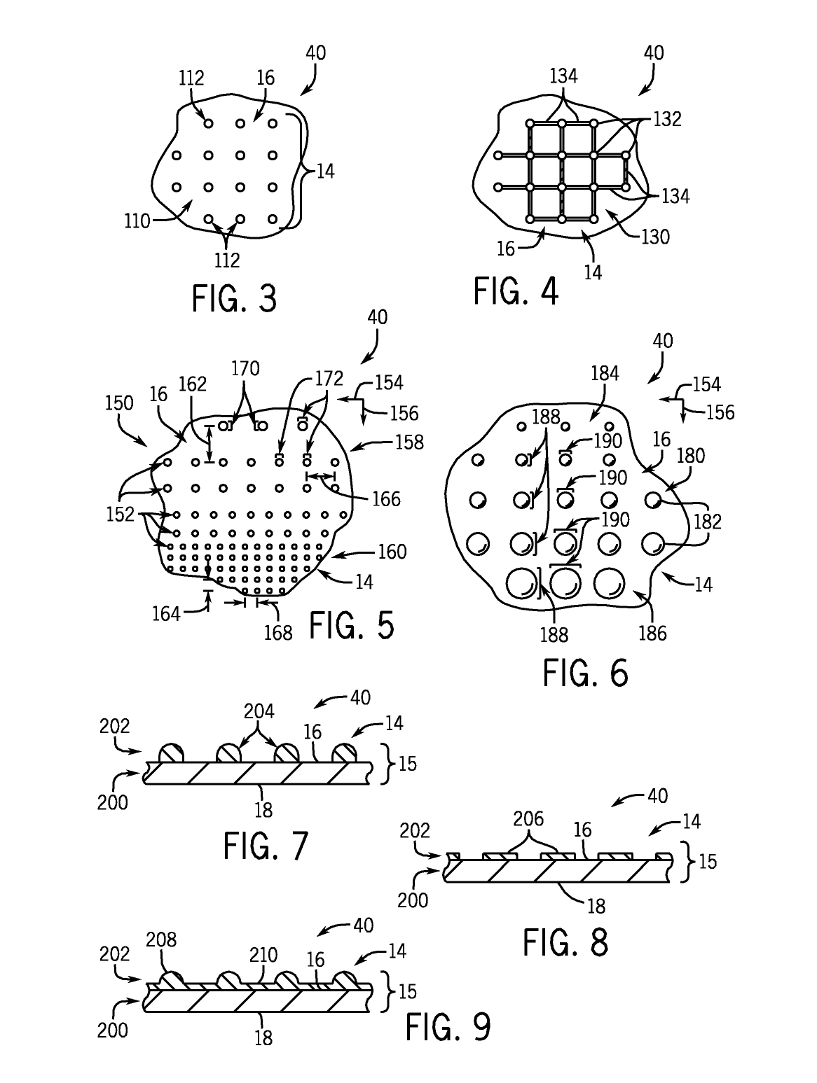

FIG. 3 is a partial surface view taken within arcuate line 3-3 of FIGS. 1 and 2, depicting an embodiment of the three-dimensional surface morphology 14 arranged in a uniform pattern 110 along the exterior surface 16 of the filter bag 40. In the illustrated embodiment, the uniform pattern 110 includes a plurality of surface features 112 distributed in a uniform density (e.g., number and/or coverage per area) along the exterior surface 16 of the filter bag 40. Furthermore, the plurality of surface features 112 has a uniform geometry, e.g., size and shape. For example, each surface feature 112 has a uniform length, width, and height relative to the exterior surface 16. In certain embodiments, the surface features 112 may be approximately 50 micrometers to 2 millimeters in length, width, and/or height. For example, the surface features 112 may be less than approximately 50, 100, 150, or 200 micrometers in length, width, and/or height. The illustrated surface features 112 are generally circular shaped features, which may be recesses and/or protrusions along the exterior surface 16. However, certain embodiments of the surface features 112 may include other geometries, such as square, rectangular, triangular, oval, pentagonal, hexagonal, chevron, semi-circular, arcuate, or other shaped geometries. Furthermore, the illustrated surface features 112 are generally disconnected from one another as discrete points along the exterior surface 16. In other embodiments, the surface features 112 may be connected to one another.

FIG. 4 is a partial surface view taken within arcuate line 3-3 of FIGS. 1 and 2, depicting an embodiment of the three-dimensional surface morphology 14 arranged in a node and link pattern 130 along the exterior surface 16 of the filter bag 40. The three-dimensional surface morphology 14 creates a less-uniform exterior surface 16, which allows particulate buildup to form in a less-uniform and more porous manner. In the illustrated embodiment, the node and link pattern 130 includes a plurality of surface nodes 132 and a plurality of links 134 along the exterior surface 16 of the filter bag 40. The links 134 are elongated surface features extending between the nodes 132, such that the nodes 132 are coupled together by the links 134. The illustrated node and link pattern 130 has a uniform density (e.g., number and/or coverage per area) and a uniform geometry (e.g., size, shape, and orientation) of the plurality of nodes 132 and the plurality of links 134. For example, each node 132 has a uniform length, width, and height relative to the exterior surface 16, and each link 134 has a uniform length, width, and height relative to the exterior surface 16. However, certain embodiments of the node and link pattern 130 may have a non-uniform density and/or a non-uniform geometry of nodes 132 and links 134. The illustrated nodes 132 are generally circular shaped features, which may be recesses and/or protrusions along the exterior surface 16. The illustrated links 134 are generally elongated rectangular features, which may be recesses and/or protrusions along the exterior surface 16. However, certain embodiments of the nodes 132 and links 134 may include other geometries, such as square, rectangular, triangular, oval, pentagonal, hexagonal, chevron, semi-circular, arcuate, or other shaped geometries.

FIG. 5 is a partial surface view taken within arcuate line 3-3 of FIGS. 1 and 2, depicting an embodiment of the three-dimensional surface morphology 14 arranged in a variable density pattern 150 along the exterior surface 16 of the filter bag 40. In the illustrated embodiment, the variable density pattern 150 includes a plurality of surface features 152 distributed in a variable or non-uniform density (e.g., number and/or coverage per area) along the exterior surface 16 of the filter bag 40. For example, a spacing between the surface features 152 may change in a vertical direction 154 and/or a horizontal direction 156. In the vertical direction 154, the illustrated surface features 152 have a decreasing vertical spacing and a decreasing horizontal spacing, thereby gradually causing an increase in density from an upper low density region 158 to a lower high density region 160. For example, the vertical spacing gradually decreases from an upper vertical spacing 162 in the upper low density region 158 to a lower vertical spacing 164 in the lower high density region 160. By further example, the horizontal spacing gradually decreases from an upper horizontal spacing 166 in the upper low density region 158 to a lower horizontal spacing 168 in the lower high density region 160. Thus, the variable density pattern 150 of the three-dimensional surface morphology 14 provides a greater density toward a bottom of the filter bag 40 and a lesser density toward a top of the filter bag 40. As discussed in further detail below, this variable density pattern 168 may be tailored to the expected particle buildup at various regions of the filter bag 40, e.g., greater buildup at the bottom and lesser buildup at the top of the filter bag 40.

As further illustrated in FIG. 5, the surface features 152 have a uniform geometry, e.g., size and shape. For example, each surface feature 152 has a uniform length 170, width 172, and height relative to the exterior surface 16. The illustrated surface features 152 are generally circular shaped features, which may be recesses and/or protrusions along the exterior surface 16. However, certain embodiments of the surface features 152 may include other geometries, such as square, rectangular, triangular, oval, pentagonal, hexagonal, chevron, semi-circular, arcuate, or other shaped geometries. Furthermore, certain embodiments of the surface features 152 may have a non-uniform geometry.

FIG. 6 is a partial surface view taken within arcuate line 3-3 of FIGS. 1 and 2, depicting an embodiment of the three-dimensional surface morphology 14 arranged in a variable sized pattern 180 along the exterior surface 16 of the filter bag 40. In the illustrated embodiment, the variable sized pattern 180 includes a plurality of surface features 182 distributed in a uniform numerical density (e.g., number per area) and a non-uniform coverage density (e.g., coverage per area) along the exterior surface 16 of the filter bag 40. For example, a geometry of the surface features 182 may change in the vertical direction 154 and/or the horizontal direction 156. In the vertical direction 154, the illustrated surface features 182 have an increasing size, thereby gradually causing an increase in coverage density from an upper low density region 184 to a lower high density region 186. For example, a size (e.g., a length 188 and a width 190) of the surface features 182 increases from the upper low density region 184 to the lower high density region 186. By further example, the size (e.g., the length 188, the width 190, and/or a height) of the surface features 182 may increase or decrease from the upper low density region 184 to the lower high density region 186. Thus, the variable sized pattern 180 of the three-dimensional surface morphology 14 provides a greater coverage density toward a bottom of the filter bag 40 and a lesser density toward a top of the filter bag 40. As discussed in further detail below, this variable sized pattern 180 may be tailored to the expected flow rates through various regions of the filter bag 40, e.g., greater flow through the bottom and lesser flow through the top of the filter bag 40.

As further illustrated in FIG. 6, the surface features 182 have a uniform shape. For example, the illustrated surface features 182 are generally circular shaped features, which may be recesses and/or protrusions along the exterior surface 16. However, certain embodiments of the surface features 182 may include other geometries, such as square, rectangular, triangular, oval, pentagonal, hexagonal, chevron, semi-circular, arcuate, or other shaped geometries. Furthermore, certain embodiments of the surface features 182 may have a non-uniform shape.

FIGS. 7, 8, and 9 are partial cross-sectional side views of the wall 15 of the filter bag 40 taken along line 7-7 of FIG. 3, illustrating a first or base layer 200 and a second or cover layer 202 with different embodiments of the three-dimensional surface morphology 14. The first and second layers 200 and 202 may be the same or different from one another. For example, the first and second layers 200 and 202 may be made out of the same or different materials. By further example, the first and second layers 200 and 202 may have different porosities, chemical resistances, wear resistances, water resistances, or any combination thereof. In the illustrated embodiment, the first layer 200 may be a fabric layer made of a fabric, such as woven or felted fabrics made of natural or synthetic fibers. Exemplary fibers include natural fiber cellulose, polyolefin, natural fiber protein, polyester, or a fluoro-carbon. Additionally, the first layer 200 may be polytetrafluroethylene (ePTFE) micro-porous membrane. The second layer 202 may be made of a fabric, either the same or different from the first layer 200, or the second layer 202 may be made of a plastic, a metal, a ceramic, or another natural or synthetic material. For example, the first and second layers 200 and 202 both may be made of a mesh fabric. By further example, the second layer 202 may be made of a polymeric material, such as acrylic, polyamide, polybutylene, polycarbonate, polypropylene, polystyrene, or polyurethane. Additionally, the second layer 202 may be made of catalytic or absorptive materials, such as Zeolites or Carbon, to obtain an additional capture effect of volatile pollutants.

The second layer 202 having the three-dimensional surface morphology 14 may be applied to the first layer 200 using a variety of techniques, such as printing, laminating, rolling, coating or spraying with a patterned mask, or any combination thereof. For example, the second layer 202 may be a mesh, weave, or patterned layer, which is laminated to the first layer 200 with an appropriate adhesive, heat (e.g., to cause partial melting or curing), or any combination thereof. By further example, the first and second layers 200 and 202 may be different portions of a one-piece wall 15, and the second layer 202 (or portion) may be patterned with the three-dimensional surface morphology 14 directly into the first layer 200 (or portion). For example, a roller with perforations and/or protrusions may be pressed and rolled against the wall 15 to create the three-dimensional surface morphology 14.

As illustrated in FIGS. 7, 8, and 9, the three-dimensional surface morphology 14 may have a variety of configurations. For example, FIG. 7 illustrates an embodiment of the second layer 202 with discrete protrusions 204 defining the three-dimensional surface morphology 14. As illustrated, the discrete protrusions 204 are disconnected from one another, such that the exterior surface 16 of the wall 15 is exposed between the discrete protrusions 204. The illustrated protrusions 204 have a semi-circular or dome-shaped geometry with uniform dimensions and spacing. However, in other embodiments, the discrete protrusions 204 may have a different shape, non-uniform dimensions, and/or non-uniform spacing along the wall 15. FIG. 8 illustrates an embodiment of the second layer 202 with discrete protrusions 206 having a rectangular shape. These discrete protrusions 206 are also disconnected from one another, and may have uniform or non-uniform dimensions and/or spacing along the wall 15. FIG. 9 illustrates an embodiment of the second layer 202 with protruding nodes 208 and base linkages 210. Similar to FIG. 7, the protruding nodes 208 have a semi-circular or dome-shaped geometry with uniform dimensions and spacing. However, the protruding nodes 208 are connected to one another via the base linkages 210, which may be discrete linkages or a common base layer of the second layer 202. Although FIGS. 7-9 illustrate three embodiments of the layers 200 and 202, any suitable configuration of layers may be employed to provide the three-dimensional surface morphology 14 on the filter bag 40.

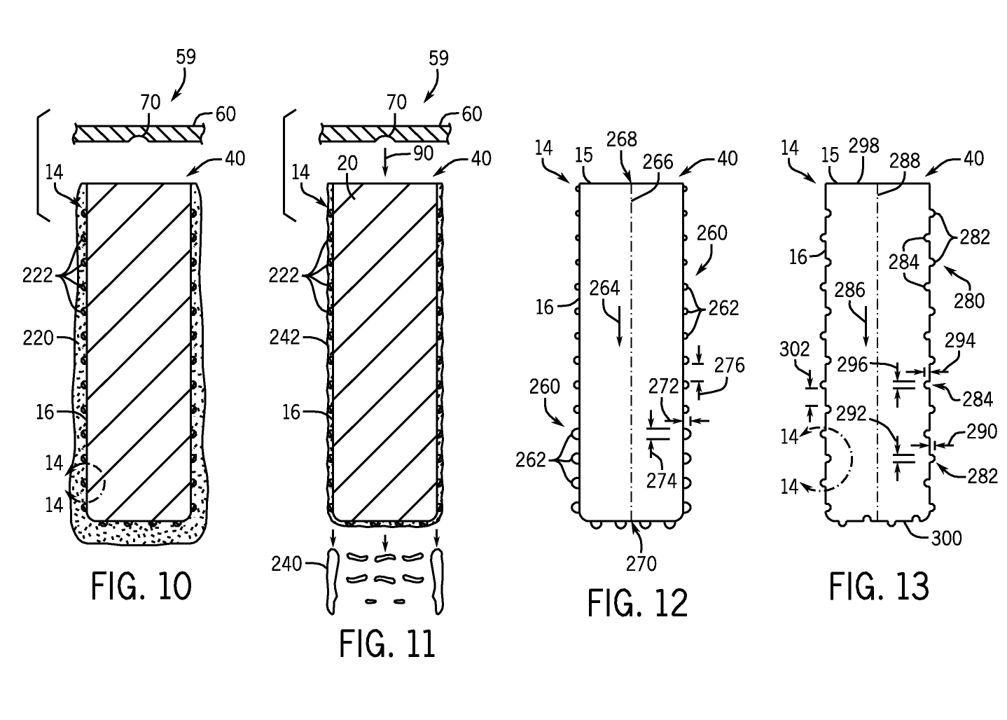

FIG. 10 is a cross-sectional side view of an embodiment of the filter bag 40 having the three-dimensional surface morphology 14 with particulate buildup 220 prior to cleaning by the pulse jet cleaning system 59. In the illustrated embodiment, the three-dimensional surface morphology 14 includes a plurality of protrusions 222 distributed along the exterior surface 16 of the filter bag 40. The illustrated protrusions 222 may be arranged in a uniform or non-uniform pattern, and the protrusions 222 may have a variety of geometries (e.g., shapes and sizes). Regardless of the specific pattern or geometry, the protrusions 222 are configured to define the three-dimensional surface morphology 14, such that the particulate buildup 220 remains relatively porous and less resistant to gas flow. In other words, the protrusions 222 are configured to increase porosity and thus reduce a pressure drop across the particulate buildup 220, as the particulate buildup 220 builds, thereby enabling a longer interval between successive cleaning operations by the pulse jet cleaning system 59. The protrusions 222 also may increase retention of the particulate buildup 220 along the filter bag 40, thereby reducing the possibility of spikes in emissions (e.g., mercury) associated with separation of the particulate buildup 220 from the filter bag 40.

FIG. 11 is a cross-sectional side view of an embodiment of the filter bag 40 having the three-dimensional surface morphology 14 releasing a first portion 240 of the particulate buildup 220 and retaining a second portion 242 of the particulate buildup 220 during cleaning by the pulse jet cleaning system 59. As discussed above, the pulse jet cleaning system 59 includes the compressed air header 62 coupled to the blowpipe 60, which ejects pulsed jets of compressed air into the filter bags 40, 42, 44, and 46. For example, pulsed jets 90 of compressed air exit the blowpipe 60 through the opening 70 and enter the interior 20 of the filter bag 40. The pulsed jets 90 shake, vibrate, and/or generally agitate the filter bag 40, thereby causing separation of the first portion 240 of the particulate buildup 220. However, the three-dimensional surface morphology 14 (e.g., protrusions 222) retain the second portion 242 of the particulate buildup 220 on the exterior surface 16 of the filter bag 40. This partial retention of the particulate buildup 220 by the three-dimensional surface morphology 14 reduces the undesirable emissions (e.g., mercury) associated with the separation of the particulate buildup 220. Thus, rather than separating all of the particulate buildup 220, the three-dimensional surface morphology 14 allows only the first portion 240 to separate from the exterior surface 16, while retaining the first portion 242. The retained second portion 240 also improves the filtering by the filter bag 40. For example, the retained second portion 240 itself may capture particulate and other undesirable contaminants in the gas flow. Again, the three-dimensional surface morphology 14 also reduces the pressure drop across the particulate buildup, thereby allowing retention of the second portion 240 and a subsequent greater amount of particulate buildup before reaching a threshold level requiring a successive cleaning operation.

FIG. 12 is a cross-sectional side view of an embodiment of the filter bag 40, illustrating the three-dimensional surface morphology 14 with a non-uniform pattern 260 of protrusions 262 disposed along the wall 15 (e.g., exterior surface 16) of the filter bag 40. As illustrated, the non-uniform pattern 260 varies in a longitudinal direction 264 along a longitudinal axis 266 of the filter bag 40. For example, the illustrated protrusions 262 vary in geometry and spacing in the longitudinal direction 264 from an opening 268 toward a bottom 270 of the filter bag 40. As illustrated, the illustrated protrusions 262 increase in height 272, length and/or width 274 (e.g., diameter) in the longitudinal direction 264. As a result, the protrusions 262 near the opening 268 are relative smaller than the protrusions 262 near the bottom 270. The illustrated protrusions 262 also decrease in spacing 276 in the longitudinal direction 264. As a result, the protrusions 262 near the opening 268 are spaced at a greater distance from one another than the protrusions 262 near the bottom 270. In certain embodiments, the protrusions 262 may continuous vary from the opening 268 to the bottom 270, while other embodiments may provide discrete steps or groups of changes in geometry and spacing from the opening 268 to the bottom 270. Although FIG. 12 illustrates the protrusions 262 distributed over the entire exterior surface 16, other embodiments may distribute the protrusions 262 over a lesser amount of the exterior surface 16, e.g., approximately 10 to 100 percent, 25 to 75 percent, or 40 to 60 percent.

FIG. 13 is a cross-sectional side view of an embodiment of the filter bag 40, illustrating the three-dimensional surface morphology 14 with a pattern 280 of protrusions 282 and recesses 284 disposed along the wall 15 (e.g., exterior surface 16) of the filter bag 40. As illustrated, the pattern 280 alternates between the protrusions 282 and the recesses 284 in a longitudinal direction 286 along a longitudinal axis 288 of the filter bag 40. For example, the illustrated pattern 280 alternates between a single protrusion 282 and a single recess 284 in the longitudinal direction 286. In other embodiments, the pattern 280 may alternate between 2 or more of the protrusions 282 and two or more of the recesses 284. However, any suitable pattern 280 of the protrusions 282 and the recesses 284 may define the three-dimensional surface morphology 14. In the illustrated embodiment, the pattern 280 may be uniform or non-uniform in geometry and/or spacing. For example, the geometry (e.g., height 290, length and/or width 292) of the protrusions 282 and/or the geometry (e.g., height 294, length and/or width 296) of the recesses 284 may increase or decrease in the longitudinal direction 286 from an opening 298 to a bottom 300 of the filter bag 40. By further example, the spacing (e.g., a horizontal spacing and/or a vertical spacing 302) may increase or decrease in the longitudinal direction 286 from the opening 298 to the bottom 300 of the filter bag 40.

FIG. 14 is a partial cross-sectional side view taken within arcuate line 14-14 of FIGS. 10 and 13, depicting the wall 15 (e.g., exterior surface 16) of the filter bag 40 having the three-dimensional surface morphology 14 with the pattern 280 of protrusions 282 and recesses 284 with retained particulate buildup 304. As discussed above, the three-dimensional surface morphology 14 may be configured to increase porosity of the particulate buildup 304 on the exterior surface 16 of filter bag 40. As the particulate contacts the exterior surface 16, the particulate buildup 304 forms in a non-uniform geometry 306 (e.g., a three-dimensional geometry) defined at least partially by the three-dimensional surface morphology 14, thereby creating a more porous and non-linear particulate buildup 304. For example, the particulate buildup 304 variably settles along the protrusions 282 and recesses 284, thereby creating a variable height and thickness of the particulate buildup 304. In some embodiments, the protrusions 282 and recesses 284 are configured to enable gas flow (e.g., air flow) and particulate settlement in a lateral direction 307, thus further varying the porosity of the particulate buildup 304. This variation in porosity, height, and thickness substantially improves gas flow 308 through the particulate buildup 304. For example, greater gas flow 308 may occur in the vicinity of the protrusions 282 and the recesses 284, as illustrated by arrows 308 in FIG. 14. The increased porosity and three-dimensional nature of the particulate buildup 304 reduces the pressure drop across the particulate buildup 304, which in turn allows a greater amount of buildup 304 before a filter cleaning operation may be used to remove the buildup 304. Additionally, the three-dimensional surface morphology 14 may be configured to increase retention of particulate buildup 304 on the exterior surface 16 of the filter bag 40, thereby enabling the particulate buildup 304 to improve filtration of the gas flow 308.

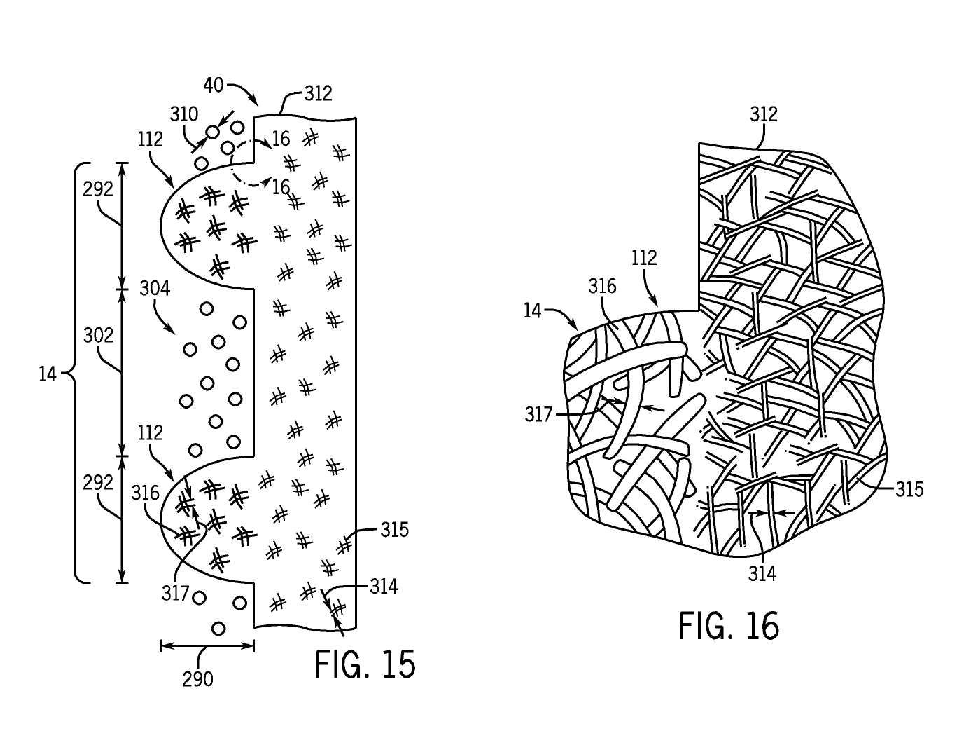

FIG. 15 is a partial cross-sectional view of a wall of a filter configured with a three-dimensional surface morphology, e.g., three-dimensional surface features 112, illustrating dimensional relationships between particulate buildup, fibers in the wall, and the three-dimensional surface morphology. A height 290 and a spacing (e.g., a horizontal spacing and/or a vertical spacing 302) of the three-dimensional surface features 112 of the three-dimensional surface morphology 14 may be configured to control porosity and retention of particulate buildup on the surface of the filter bag 40. For example, in some embodiments, the height 290 may be at least a minimum height to increase the porosity of the particulate buildup 304 on the surface of the filter bag 40. Further, the height 290 may be increased beyond the minimum height to increase retention of the particulate buildup 304 on the surface of the filter bag 40. For example, the surface feature height 290 may be increased to retain particulate buildup 304 within a thickness range of approximately 0 to 20, 0 to 15, or 5 to 10 millimeters after cleaning operations (e.g., pulse jet cleaning).

Additionally, in some embodiments, the three-dimensional surface morphology 14 may be altered based upon characteristics of the particulate that is to be filtered. In some embodiments, the surface features 112 of the three-dimensional surface morphology 14 may have a minimum spacing (e.g., a horizontal spacing and/or a vertical spacing 302) and a minimum height 290 greater than the mass mean diameter of a plurality of particles to be filtered. The three-dimensional surface features 112 may have a spacing 302 in the range of approximately 1 to 200, 1 to 100, 5 to 50, or 10 to 25 times the size of the mass mean diameter 310 of the particulate buildup 304. In certain embodiments, the spacing 302 may be greater than approximately 2, 3, 4, 5, 6, 7, 8, 9, 10, 15, or 20 times the size of the mass mean diameter 310 of the particulate buildup 304. For example, in coal ash filtration, a typical coal ash particulate mass mean diameter may be ten microns, and thus the filter bag 40 may be configured to have a spacing 302 of approximately 0.5 to 5 or 1 to 2 millimeters between the surface features 112. The height 290 of the surface features 112 may also be configured based upon the mass mean diameter 310 of the particulate buildup 304. The surface features 112 may have a minimum height 290 greater than the mass mean diameter 310 and a maximum height 290 up to approximately 500 times the mass mean diameter 310. In certain embodiments, the height 290 range may be between approximately 1.5 to 150, 5 to 100, or 10 to 50 times the mass mean diameter 310.

Furthermore, characteristics of the surface features 112 may be altered based upon the fiber characteristics of the wall 312 having the three-dimensional surface morphology 14. For example, the plurality of surface features 112 may have a minimum spacing (e.g., horizontal spacing and/or a vertical spacing 302), a minimum height 290, and a minimum width 292 each greater than the mean diameter 314 of the fibers 315 making up the wall 312. In some embodiments, the height 290, width 292, and spacing (e.g., horizontal spacing and/or a vertical spacing 302) of the surface features 112 may range between approximately 2 to 1000, 2 to 500, 2 to 100, or 2 to 50 times the mean diameter 314 of the fibers 315 of the wall 312. For example, the height 290, width 292, and spacing (e.g., horizontal spacing and/or a vertical spacing 302) of the surface features 112 may be greater than approximately 2, 3, 4, 5, 6, 7, 8, 9, 10, 15, 20, or 25 times the mean diameter 314 of the fibers 315 of the wall 312

FIG. 16 is a partial cross-sectional view taken within arcuate line 16-16 of FIG. 15, further illustrating the dimensional relationships between wall fibers 315 and a three-dimensional surface morphology 14 with fibers 316. As illustrated, the three-dimensional surface morphology fibers 316 may have a mean diameter 317 greater than the mean diameter 314 of the wall fibers 315. The mean diameter 317 of the three-dimensional surface morphology fibers 316 may range between approximately 2 to 100, 20 to 80, or 30 to 50 times the size of the mean diameter 314 of the wall fibers 315. For example, the mean diameter 317 may be at least greater than approximately 1.5, 2, 2.5, 3, 4, 5, 6, 7, 8, 9, 10, 15, or 20 times the mean diameter 315. Additionally, the spacing of the three-dimensional surface morphology fibers 315 and wall fibers 316 may differ, creating varied porosities between the wall 312 and the three-dimensional surface morphology 14. For example, in FIG. 16, the porosity of the three-dimensional surface morphology 14 may be greater than the porosity of the wall 312, because the wall fibers 315 have a smaller mean diameter 314 and are more tightly spaced than the three-dimensional surface morphology fibers 316.

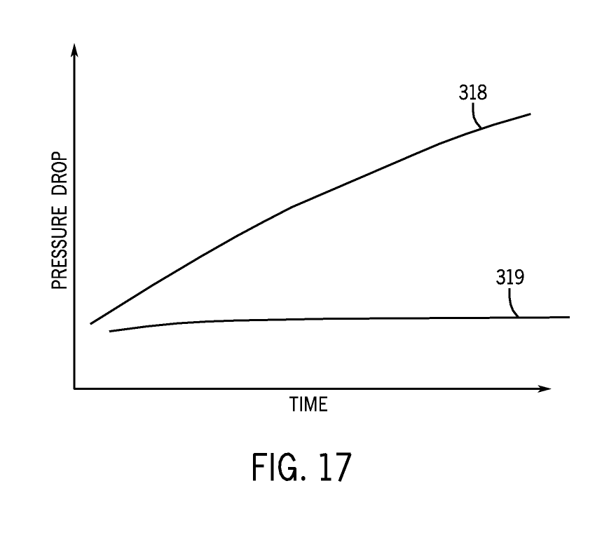

FIG. 17 is a graph of pressure drop versus time, illustrating the difference between a filter having a three-dimensional surface morphology (plot 318) and a filter without a three-dimensional surface morphology (plot 319). As illustrated, the plot 318 represents an increasing pressure drop over time when a three-dimensional surface morphology is not present on the filter. In contrast, the plot 319 represents a steady (or minimally changing) pressure drop over time when a three-dimensional surface morphology is present on the filter. Thus, the disclosed embodiments of three-dimensional surface morphologies reduce the tendency for the pressure drop to increase over time, as particulate builds up on the filter. Again, the three-dimensional surface morphology increases porosity and improves flow through the filter and any particulate, such that filter performance is maintained for longer durations of time. In turn, the reduced pressure drop over time enables less frequent filter cleanings, thereby reducing undesirable spikes in certain emissions, such as mercury emissions (e.g., mercury sorbed in an activated carbon sorbent).

FIG. 18 is a cross-sectional side view of an embodiment of an accordion-style filter bag 40 having the three-dimensional surface morphology 14. In the illustrated embodiment, the accordion shaped filter bag 40 has a non-linear wall 320 defined by a zigzagging pattern of outwardly angled portions 322 and inwardly angled portions 323, which alternate one after another. However, the zigzagging pattern of the wall 320 is relatively large-scale compared with the three-dimensional surface morphology 14, which extends along the angled portions 322 and 324. As discussed above, the three-dimensional surface morphology 14 may include a uniform or non-uniform pattern of recesses and/or protrusions 326. However, the three-dimensional surface morphology 14 is defined as a geometry along the exterior surface 16 of the filter bag 40, rather than the geometry of the wall 320 itself. The size and shape of the three-dimensional surface morphology 14 may vary between different implementations. For example, the protrusions 326 and/or recesses may be less than approximately 50, 100, 150, or 200 micrometers in length, width, and/or height. The three-dimensional surface morphology 14 may be applied along the entire exterior surface 16 or a portion of the exterior surface 16 of the accordion shaped filter bag 40.

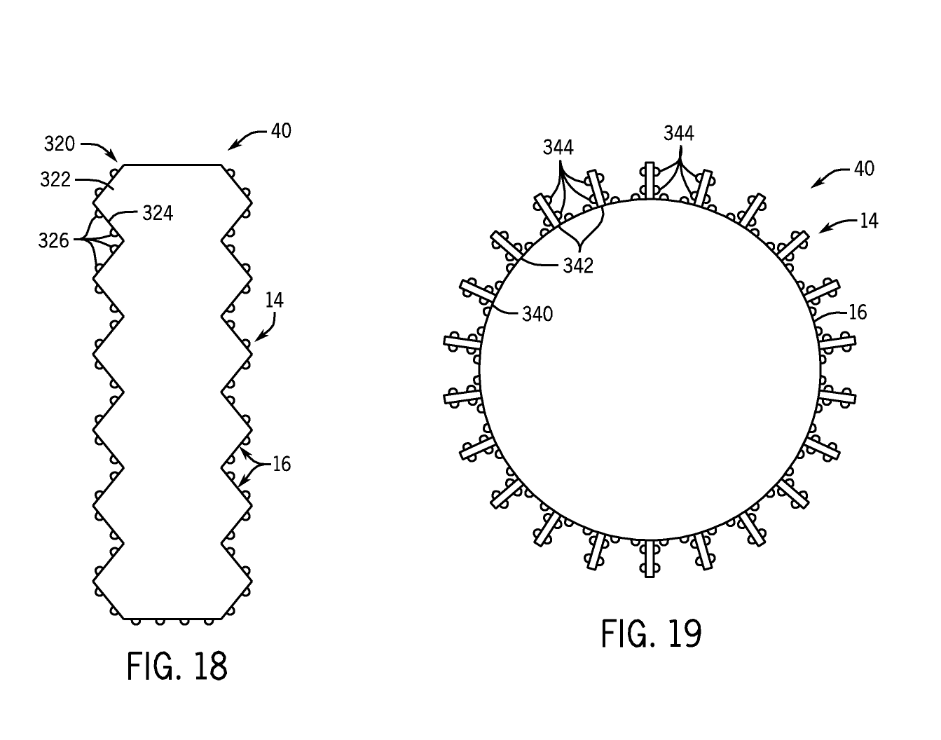

FIG. 19 is a cross-sectional top view of an embodiment of a ribbed filter bag 40 having the three-dimensional surface morphology 14. In the illustrated embodiment, the ribbed filter bag 40 has a wall 340 with a plurality of ribs 342 protruding outwardly from the exterior surface 16 of the wall 340. However, the ribs 342 of the wall 340 are relatively large-scale compared with the three-dimensional surface morphology 14, which extends along the wall 340 and the ribs 342. As discussed above, the three-dimensional surface morphology 14 may include a uniform or non-uniform pattern of recesses and/or protrusions 344. However, the three-dimensional surface morphology 14 is defined as a geometry along the exterior surface 16 of the filter bag 40, rather than the geometry of the wall 320 itself. The size and shape of the three-dimensional surface morphology 14 may vary between different implementations. For example, the protrusions 344 and/or recesses may be less than approximately 50, 100, 150, or 200 micrometers in length, width, and/or height. The three-dimensional surface morphology 14 may be applied along the entire exterior surface 16 or a portion of the exterior surface 16 of the ribbed filter bag 40. In additional embodiments, the filter bag 40 may include a pleated filter bag having a plurality of pleats. The three-dimensional surface morphology 14 may be applied along the plurality of pleats of the pleated filter bag 40.

Technical effects of the invention include a filter bag with a three-dimensional surface morphology capable of collecting particulate in a more porous manner. A more porous particulate buildup results in a lower pressure drop, and effectively lengthens the duration of time before the pressure drop reaches a threshold level requiring a cleaning operation. Thus, the cleaning operation may occur less frequently, and thus reduce the overall number of spikes in undesirable emissions (e.g., mercury) associated with cleaning operations. Furthermore, the three-dimensional surface morphology may retain a portion of particulate buildup after the cleaning operation, such that the retained portion improves filtration after the cleaning operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a filter comprising a wall, a surface on the wall, and a three-dimensional surface morphology disposed along the surface, wherein the three-dimensional surface morphology is configured to reduce a pressure drop across the filter.

2. The system of claim 1, wherein the three-dimensional surface morphology is configured to increase porosity of a particulate buildup on the surface.

3. The system of claim 1, wherein the three-dimensional surface morphology is configured to increase retention of a particulate buildup on the surface.

4. The system of claim 1, wherein the three-dimensional surface morphology comprises a plurality of surface features having a height to control porosity and retention of particulate buildup on the surface, the height is at least a minimum height to increase the porosity, and the height is greater than the minimum height to increase the retention.

5. The system of claim 1, wherein the three-dimensional surface morphology comprises a plurality of protrusions, a plurality of recesses, or a combination thereof, distributed along the surface.

6. The system of claim 1, wherein the filter is configured to filter a plurality of particles having a mass mean diameter, and the three-dimensional surface morphology comprises a plurality of surface features having a minimum spacing and a minimum height greater than the mass mean diameter.

7. The system of claim 1, wherein the wall comprises a plurality of first fibers having a first mean diameter, the three-dimensional surface morphology comprises a plurality of surface features having a minimum spacing, a minimum height, and a minimum width greater than the first mean diameter.

8. The system of claim 1, wherein the wall comprises a plurality of first fibers having a first mean diameter, the three-dimensional surface morphology comprises a plurality of second fibers having a second mean diameter, and the second mean diameter is greater than the first mean diameter.

9. The system of claim 1, wherein the filter comprises a first layer and a second layer, the first layer comprises the surface, the second layer comprises the three-dimensional surface morphology, the first layer is made of a first material, the second layer is made of a second material, and the first and second materials are different from one another.

10. The system of claim 1, wherein the filter comprises a first layer and a second layer, the first layer comprises the surface, the second layer comprises the three-dimensional surface morphology, the first layer has a first porosity, the second layer has a second porosity, and the first and second porosities are different from one another.

11. The system of claim 1, wherein the three-dimensional surface morphology comprises a non-uniform pattern.

12. The system of claim 11, wherein a geometry or concentration of the non-uniform pattern progressively changes in a direction along the filter.

13. A system, comprising:
a filter comprising a wall, a surface on the wall, and a three-dimensional surface morphology disposed along the surface, wherein the three-dimensional surface morphology comprises a non-uniform pattern, and the non-uniform pattern progressively changes in a direction along the filter.

14. The system of claim 13, wherein the three-dimensional surface morphology is configured to reduce a pressure drop across the filter, the three-dimensional surface morphology comprises a plurality of surface features having a height to control porosity and retention of particulate buildup on the surface, the height is at least a minimum height to increase the porosity, and the height is greater than the minimum height to increase the retention.

15. The system of claim 13, wherein the wall comprises a first layer and a second layer, the first and second layers are made of different materials or have different porosities, the second layer comprises the three-dimensional surface morphology having the non-uniform pattern, and the three-dimensional surface morphology comprises a plurality of protrusions or a plurality of recesses.

16. The system of claim 15, wherein the first layer comprises an ePTFE micro-porous membrane, or the second layer comprises a catalytic or adsorptive material, or a combination thereof.

17. The system of claim 13, wherein the wall comprises a plurality of first fibers having a first mean diameter, the three-dimensional surface morphology comprises a plurality of surface features having a minimum spacing, a minimum height, or a minimum width greater than the first mean diameter.

18. The system of claim 13, wherein the wall comprises a plurality of first fibers having a first mean diameter, the three-dimensional surface morphology comprises a plurality of second fibers having a second mean diameter, and the second mean diameter is greater than the first mean diameter.

19. A method, comprising:
decreasing a pressure drop through a filter via a three-dimensional surface morphology disposed along a surface of the filter; and
increasing a retention of a particulate buildup along the surface of the filter via the three-dimensional surface morphology.

20. The method of claim 19, wherein decreasing a pressure drop comprises enabling lateral flow into a plurality of surface features of the three-dimensional surface morphology, and the plurality of surface features have a minimum height to increase a porosity of the particulate buildup.
